(19) United States
(12) Patent Application Publication
(10) Pub. No.: US 2008/0171556 A1
(43) Pub. Date: Jul. 17, 2008

(54) DATABASE UPDATE SYSTEMS

(75) Inventor: Mark Ian Carter, Reading (GB)

Correspondence Address: BAINWOOD HUANG & ASSOCIATES LLC, 2 CONNECTOR ROAD, WESTBOROUGH, MA, 01581, US

(73) Assignee: CONNECT SPOT LTD., Aldermaston (GB)

(21) Appl. No.: 12/015,062

(22) Filed: Jan. 16, 2008

(30) Foreign Application Priority Data
Jan. 17, 2007 (GB) 0700876.6

(51) Int. Cl. H04Q 7/20; G06F 12/00

(52) U.S. Cl. 455/456.1; 707/201; 707/E17.018

(57) ABSTRACT

In one arrangement, a method of operating a mobile user terminal in a communications system includes monitoring received broadcast signals and deriving first identification data of fixed wireless nodes from the received broadcast signals. The method includes using data derived from a stored database in combination with the derived first identification data in order to provide a service to a user of a mobile user terminal. The method includes deriving update data from at least the derived first identification data and transmitting the derived update data to a database administration node in order to allow the stored database of fixed wireless nodes to be updated.

### FIELD OF THE INVENTION

The present invention relates to database update systems, in particular but not exclusively to a method of updating a stored database of fixed wireless nodes. The invention also relates to apparatus, and computer software, arranged to conduct the method of the invention.

### BACKGROUND

Examples of fixed wireless nodes include Wi-Fi access points. There are literally millions of Wi-Fi access points currently deployed across the globe today. Positioning systems are known which use a database of known Wi-Fi access points to calculate a location of Wi-Fi enabled devices. The calculated position may then be used by the terminal for location-based services. This is an alternative to satellite positioning systems, which can be relatively costly and unreliable in urban areas.

US patent application US 2006/200843, whose applicant is Skyhook Wireless, relates to location-based services and to methods and systems of encoding and compression of a location beacon database. The location-based services system has a reference database of fixed wireless nodes in a target area, each fixed wireless node being identified in the database by a Media Access Control (MAC) address and a calculated geographical location or a power profile. The MAC addresses and geographical locations of the fixed wireless nodes may be encoded to facilitate storage and/or transmission of the database contents to Wi-Fi enabled devices using the system.

The Wi-Fi enabled devices include Wi-Fi positioning software which receives data derived from signal beacons broadcast by the fixed wireless nodes. The device compares observed fixed wireless nodes with those in the reference database of fixed wireless nodes, which may or may not be stored on the device, and calculates the position of the Wi-Fi enabled device using characteristics of the received signal beacons, the characteristics including the MAC address of each fixed wireless node and the strength of the signal received from each fixed wireless node. The calculated position is then fed to one or more location-based applications.

The database of fixed wireless nodes is compiled by scanning every street in a given area using scanning vehicles having a global positioning system (GPS) device and a wireless radio device. The fixed wireless nodes detected by the vehicle are recorded in the database in conjunction with GPS location information. Such a method of building a location beacon database is described in US patent application US 2006/095348, whose applicant is Skyhook Wireless.

A problem with this method is that, in view of the fact that the number of fixed wireless nodes deployed across the globe continues to grow, it becomes extremely time-consuming and costly to keep an accurate record not only of newly deployed fixed wireless nodes, but also of existing fixed wireless nodes which have been moved to a new location or have been removed entirely.

It is an object of the invention to provide an improved system for updating a database of fixed wireless nodes.

### SUMMARY

In accordance with one aspect of the present invention, there is provided a method of operating a mobile user terminal in a communications system, the mobile user terminal having access to data derived from a stored database of fixed wireless nodes, said stored database identifying fixed wireless nodes which are geographically dispersed and which broadcast a signal containing at least first identification data, said fixed wireless nodes being identified in said stored database by said first identification data, said method comprising the steps of:

(a) monitoring received broadcast signals;

(b) deriving first identification data of fixed wireless nodes from said received broadcast signals;

(c) using data derived from said stored database in combination with said derived first identification data in order to provide a service to a user of said mobile user terminal;

(d) deriving update data from at least said derived first identification data; and

(e) transmitting said derived update data to a database administration node in order to allow said stored database of fixed wireless nodes to be updated.

The invention proposes for the mobile users, which themselves are using the database to obtain services, to provide update data to the stored database of fixed wireless nodes. The method has the advantage that a physical scan of every street in a given area, using for instance a fleet of scanning vehicles, need not be conducted on a regular basis. Instead, the updates are derived through every day usage of the system. The more users there are the more accurate and up-to-date the database can be.

In accordance with a second aspect of the present invention, there is provided a method of updating a stored database of fixed wireless nodes accessed via a database administration node in a communications system, said stored database identifying fixed wireless nodes which are geographically dispersed and which broadcast a signal containing at least first identification data, said fixed wireless node being identified in said database by first identification data, said method comprising the steps of:

receiving update data at said stored database from a service application of at least one mobile user terminal, said service application using data derived from said stored database in combination with first identification data which is derived from broadcast signals received at said at least one mobile user terminal in order to provide a service to a user of said mobile user terminal, said update data being derived from said derived first identification data; and updating said fixed wireless nodes database with said received update data.

In accordance with a third aspect of the present invention, there is provided a system for updating a stored database of fixed wireless nodes in a communications system, said database identifying fixed wireless nodes which are geographically dispersed and which broadcast a signal containing first identification data, said fixed wireless node being identified in said database by said first identification data, said system including:

at least one mobile user terminal; and

communication means for allowing a service application of said at least one mobile user terminal to transmit update data to said stored database, said service application using data derived from said stored database in combination with first identification data derived from broadcast signals received at said at least one mobile user terminal in order to provide a service to a user of said mobile user terminal, said update data being derived from said derived first identification data.

Further aspects of the invention are set out in the appended claims.

Further features and advantages of the invention will become apparent from the following description of preferred embodiments of the invention, given by way of example only, which is made with reference to the accompanying drawings.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a diagram giving an overview of the system according to a first embodiment of the present invention;

FIG. 2 shows the user interface of the database service application of the invention, whereby a search for a fixed wireless node is initiated;

FIG. 3 shows a set of search results based on user entries provided by the database service application;

FIG. 4 shows a user interface for logging into a site using credentials stored in the credentials wallet;

FIG. 5 is a flow diagram showing a procedure carried out by the database service application of the user terminal for determining update data according to a first embodiment of the present invention;

FIG. 6 shows a set of fixed wireless nodes details based on received broadcast signals at a user terminal;

FIG. 7a shows the user interface of the database service application of the invention, whereby the details of a new fixed wireless node are edited by a user according to a first embodiment of the present invention;

FIG. 7b shows the user interface of the database service application of the invention, whereby the details of a new fixed wireless node are previewed by a user according to a first embodiment of the present invention;

FIG. 8 is a flow diagram showing an update procedure carried out by the database service application on the user terminal; and

FIG. 9 is a schematic diagram showing an example of an update procedure between three mobile user terminals and a stored database of fixed wireless nodes according to both embodiments of the present invention.

### DETAILED DESCRIPTION

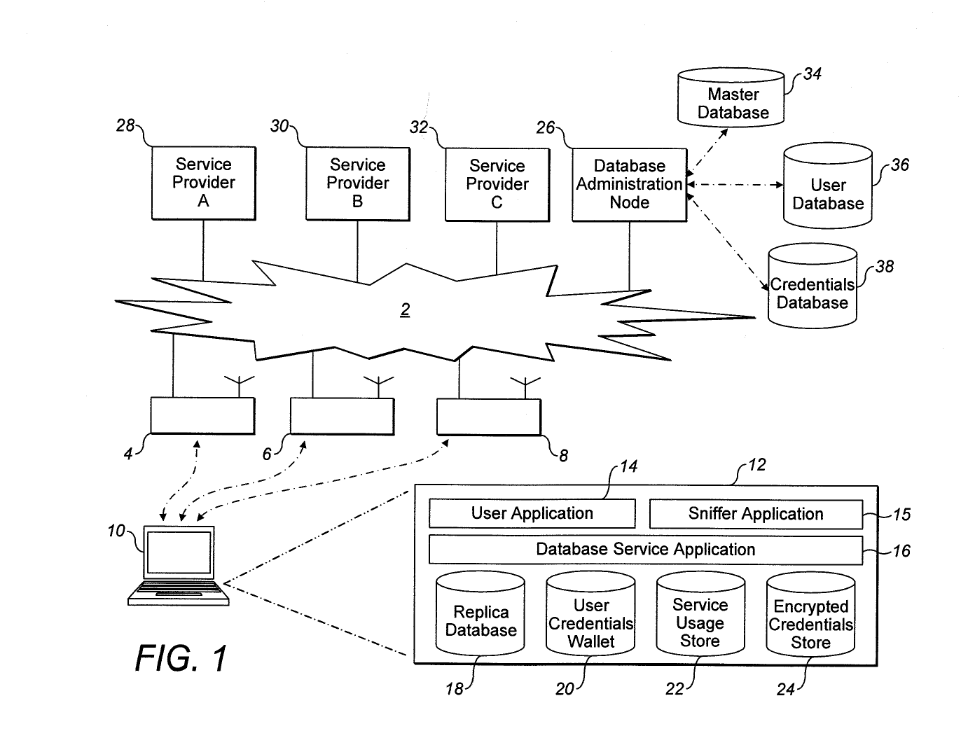

FIG. 1 shows an overview of the system according to a first embodiment of the present invention, in which a communications network 2, which in this embodiment is the Internet, is accessed via a plurality of fixed wireless nodes 4, 6, 8. Each of these fixed wireless nodes implements an aerial and a radio interface (not shown) whereby access to the communications network 2 can be given to user terminals communicating with the fixed wireless node via a radio communications protocol.

In the system according to an embodiment of the invention, the fixed wireless nodes 4, 6, 8, implement an IEEE 802.11 wireless communications standard (examples include variants of the 802.11 standard such as IEEE 802.11a, IEEE 802.11b, IEEE 802.11g). The 802.11 standards are commonly referred as WiFi™, which is a trademark of the Wifi Alliance.

One or more of the fixed wireless nodes may alternatively, or in addition, implement an IEEE 802.16 wireless communication standard (examples include variants of the 802.16 standard such as IEEE 802.16a, IEEE 802.16b, IEEE 802.16 g). The 802.16 standards are commonly referred by the term WiMaX™, which is a trademark of the WiMax Forum.

FIG. 1, by way of example, shows a user terminal 10 located in the coverage region of each of the three illustrated fixed wireless nodes 4, 6, 8. The user terminal 10, which may be a mobile user terminal, may be a portable computer, such as a laptop computer; a personal digital assistant (PDA); a smart phone; or a similar device, and includes a data storage device 12, such as a hard drive, on which various different software applications are stored along with user data. The software applications include a set of one or more user applications requiring network access, such as a web browser, an email client application and a Voice-over-IP (VoIP) telephony application. Of these a representative single user application 14 is shown and referred to below, however it should be understood that one or more of these may be present and operated in the manner described. The software applications also include a “sniffer” application 15, which will be described in further detail, and a database service application 16 according to the present invention. The database service application 16 controls network access so as to provide the user application 14 with network connectivity.

In a preferred embodiment, associated with the database service application 16 is a replica database 18, which includes geographical location data and identification data for a large number of geographically dispersed fixed wireless nodes and a user credentials store or “wallet” 20. In a preferred embodiment, the replica database 18 is derived from a master database 34 of fixed wireless nodes, in that a copy is created and downloaded to the user terminal. However, it should be understood that the user terminal may not include a replica database 18 but may instead query and receive information from the master database directly. The wallet stores a plurality of sets of user credentials, each associated with a different network access right which the user is entitled to. The user credentials are for presentation to a service provider to authenticate the user, thereby to allow the user to gain network access rights associated with the credentials. The user credentials may also, or alternatively, include user identification data in the form of a security key, such as a Wired Equivalent Privacy (WEP) key.

Such network access rights may be in the form of a type of rights referred to as a “voucher”, which is a set of credentials which is typically purchased and which entitles the user to a certain limited amount of network access. Typically, the credentials will be in the form of limited validity user credentials. Such vouchers can be purchased in a variety of ways, including on-line vouchers and physical tokens such as scratch-off cards. Purchasing a voucher will typically provide the user with a username and password which are of limited validity. Once the voucher is used up, the credentials are no longer valid and can be discarded.

Other types of access rights which are authenticated using credentials include subscription rights, whereby a user has a long term relationship with a service provider, and the subscription credentials are used to authenticate the user. Such a subscription will typically involve a billing relationship, whereby the user is occasionally billed for the network usage which the user obtains via the subscription.

A service provider will typically require a login using credentials and monitor the usage session and keep a record of amounts of usage monitored during the user's sessions. If the usage monitored exceeds a pre-set threshold, the service provider may terminate the session and prevent login using the same credentials. Alternatively, the access rights may provide for unlimited usage during a given period of validity associated with the credentials. Once the period of validity ends, the service provider may terminate the session and prevent login using the same credentials.

Also associated with the database service application 16 is a service usage store 22 and 24. The database service application 16 interworks with a database administration node 26, and sets up a communications session with the database administration node 26 during a network access session, through which updates can be sent between the database service application 16 and database administration node 26.

In a preferred embodiment, associated with the database administration node 26 of the communications network is, in addition to the master database 34, a user database 36 which stores user specific data in the form of credentials sales records and a credentials database 38.

Each fixed wireless node 4, 6, 8 may be a network access node, for example a private access fixed wireless node, and accessible only to users associated specifically with the fixed wireless node, such as the fixed wireless nodes of a corporate wireless local area network (WLAN). However, there are also many service providers which provide public access fixed wireless nodes. These public access fixed wireless nodes can be, in some cases, freely available. In the majority of cases, the fixed wireless nodes are publicly available, conditioned upon users purchasing access. In order to prevent users who have not purchased access from using the facilities provided by the public access fixed wireless nodes, the fixed wireless nodes are protected by means of an authentication procedure. The procedure is for authenticating authorised users who have purchased the right to network access via the fixed wireless nodes belonging to the service provider in question. A single service provider may own, and therefore control access to, a large number of fixed wireless nodes which are geographically dispersed. The authentication may be web-based and/or authentication client-based. Typically, the fixed wireless nodes will include a web server application for transmitting a login web page to a user terminal attempting to gain network access via the fixed wireless node. The web page will include a number of form fields for entering a set of credentials, typically username and password, which the user must fill in and transmit back to the fixed wireless node. The fixed wireless node may also provide for automated login using an authentication client provided on the user terminal. In this case, the fixed wireless node implements a fixed wireless node authentication protocol such as GIS (a proprietary protocol used by the company IPASS) or the WISPr protocol (an IETF standard). In both cases, the user credentials are passed over to the fixed wireless node for authentication.

The service provider systems 28, 30, 32 may include a remote authentication server, typically a RADIUS or AAA server, for performing authentication. The fixed wireless node transmits the received credentials to the authentication server, and if authentication is successful, permits the user network access, typically for web browsing, email download, etc, but many other data communications types are also performed in this way, including Voice Over Internet Protocol (VoIP) telephone calls, using the user application 14. Once authenticated, the user's session is monitored, and if the validity of the credentials used expires, the user's session is terminated and the user's web browser application is redirected to the login web page.

Typically, in high density areas, a user will have a choice of public access fixed wireless nodes, and this situation is illustrated as an example in FIG. 1. In other areas, a user will have no available public access fixed wireless node, and will use the database service application 16 to identify a proximate fixed wireless node for which the user has, or can purchase, credentials. If no such proximate fixed wireless node exists, network access may be provided via network access provided by alternate means which are within the user terminal's capabilities. For example, a smart phone may include a built-in cellular radio interface whereby such alternate network access may be provided. A laptop may include a cellular radio interface card to provide such alternate network access.

Each of the fixed wireless nodes 4, 6, 8 illustrated in FIG. 1 is a public access fixed wireless node. Each is controlled by a different service provider. In this example, fixed wireless node 4 is controlled by a first service provider (A) 28, fixed wireless node 6 is controlled by a second service provider (B) 30 and fixed wireless node 8 is controlled by a third service provider (C) 32. The replica database 18 includes directory information for the fixed wireless nodes, including geographical location data for identifying the location of the fixed wireless nodes, but also identification data for identifying the fixed wireless nodes from either a Service Set Identifier (SSID), which is unique to a service provider which may control a large number of fixed wireless nodes, or a Media Access Control (MAC) address, which is unique to a fixed wireless node. Each fixed wireless node broadcasts a signal comprising both its SSID and MAC address.

The replica database 18 associated with the database service application 16 includes, where known, the MAC address of each fixed wireless node. Thus, a fixed wireless node can be identified by means of the MAC address alone, if the user is within the coverage of the fixed wireless node. If the replica database 18 associated to the database service application 16 does not currently hold a MAC address for a public access fixed wireless node which nevertheless includes an entry within the replica database, it can be identified by means of the SSID and/or the geographical data held within the database service application for the fixed wireless node.

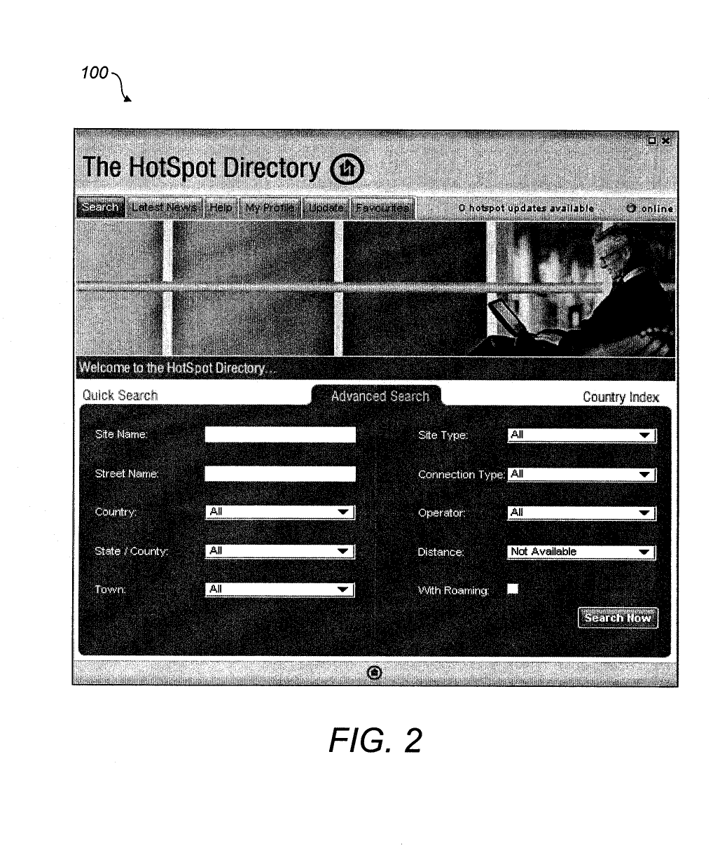

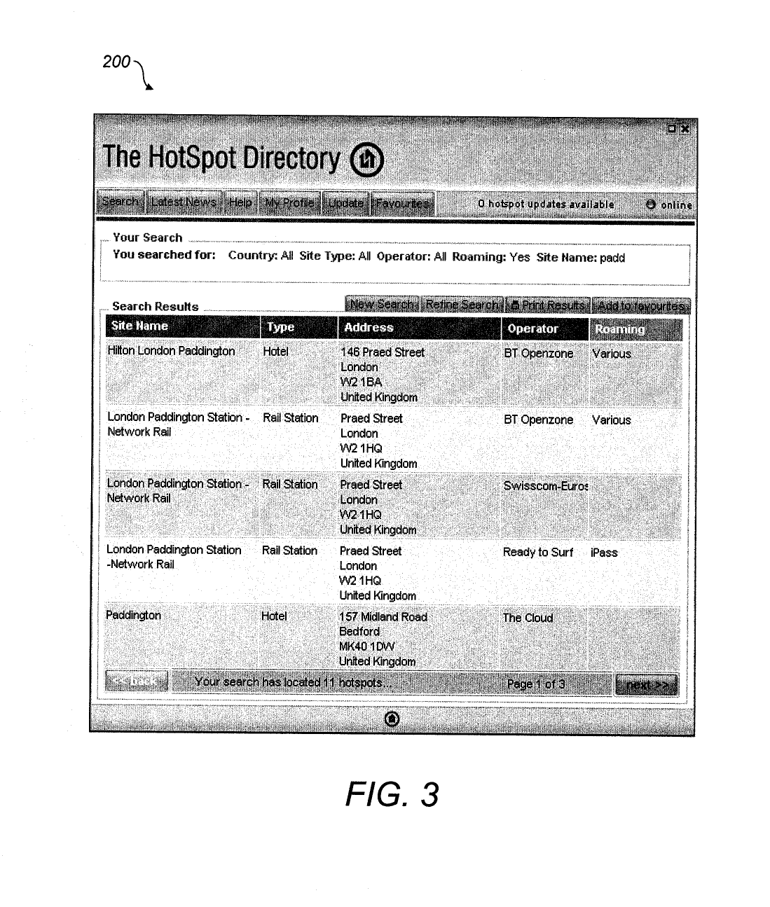

Using a user interface similar to that shown in FIG. 2, namely a search input screen 100, a user may conduct an SSID-based search which is carried out by the database service application 16 in order to find all fixed wireless nodes belonging to a given service provider. The search input screen further allows the user to enter text, such as a site name, a street name, etc., which is used to match against site entries in the replica database 18. The search can be further limited by geographical parameters, such as geographical location coordinates, a geographical location name and/or postcode data (for example a postcode prefix). A graphic search may also be conducted by a user using a map-based interface (not shown), whereby a user can click on a map to search for relevant sites within a specific geographic area. Even if the database service application 16 does not currently hold an entry for the fixed wireless node, the identity of the service provider can be determined by means of the SSID received from the fixed wireless node. In any of these ways, a set of search results can be provided which identifies a set of one or more fixed wireless nodes. Then, on a user interface, the user can be shown, via a directory search results screen, all of the fixed wireless nodes in the replica database which fall within the search parameters specified. An exemplary search results screen 200 is shown in FIG. 3. If no results are identified using a search criteria entered by the user, the user has the option to conduct a proximity-based search. Note that, alternatively, the database service application 16 may automatically conduct a proximity search without requiring user initiation. When a proximity-based search is carried out, the database service application 16 searches the replica database 18 using parameters which may not necessarily be entered by the user. For example, the parameters may be a set of geographical coordinates derived from a positioning system comprised on the user terminal which is used to determine further sites in the proximity of the terminal. The positioning system is preferably a satellite positioning system, even more preferably a global positioning system (GPS). Note that these further sites may not necessarily currently be within signal range of the terminal. However, the user can move to within the signal range of the site once the location of the site has been identified via the replica database 18.

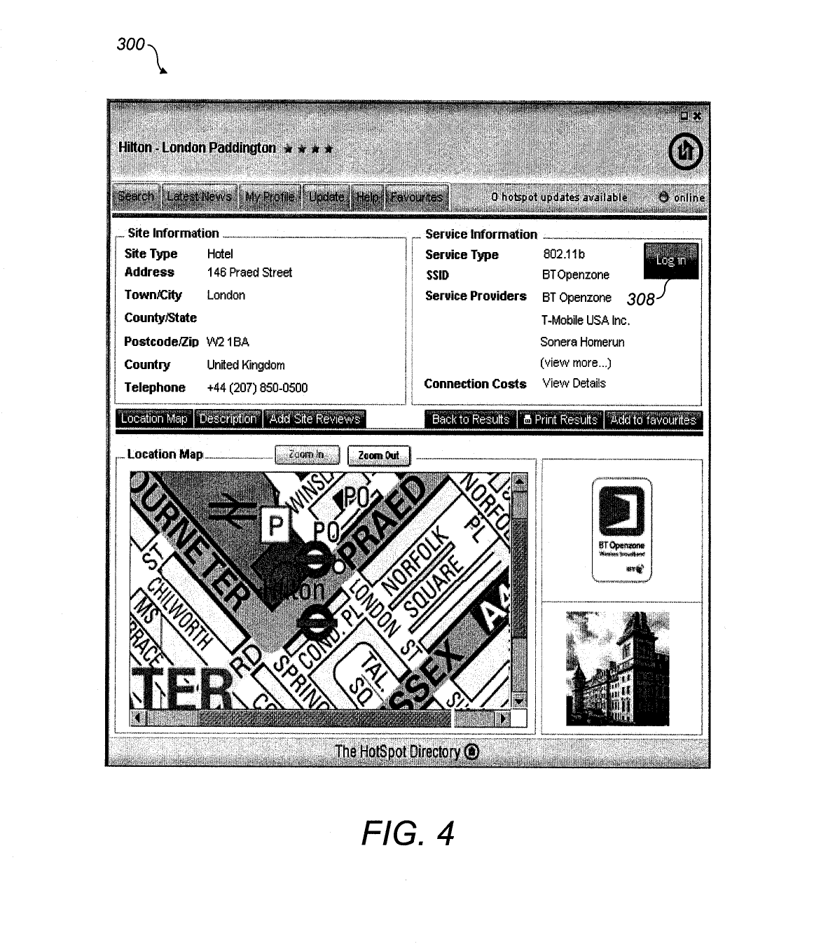

The user credentials wallet 20 identifies each voucher by means of an SSID of the service provider, and then the database service application 16 can match this to the SSID of the fixed wireless node to determine whether the user has authorisation to receive network access via the fixed wireless node. The wallet includes a table showing information relating to a set of credentials including service provider, voucher type, duration, first login, valid until, issued date, expiry date. Typically, the user will have credentials valid only for some of the public access fixed wireless nodes, and therefore the choice of the user are more limited than the full set of public access fixed wireless nodes covering the user's location. Once a user has selected a fixed wireless node, referred herein also as a “site”, from the search results screen 100, the database service application 16 attempts to match the site to credentials stored in the user credentials wallet, and then preferably indicates in a search result screen, either individual results or a combined result screen, whether the user currently has authorisation to receive network access via the fixed wireless node in question. An exemplary result screen 300 for logging into a site using credentials stored in the credentials wallet is shown in FIG. 4. An indication that the user is authorised is preferably given in a form associated with an automated login function, which when activated, causes the application to perform a login, either via an auto-fill of the login web page form with the credentials, or by using an authentication client such as a WISPr client. The indication is preferably a login button 308 on the result screen 300. Once logged into a site, the user may be provided with one or more services via the user application, such as an email download service, a VoIP telephony service and a web browsing service. The database service application 16 may also display a location map on the user interface indicating the geographical location of the fixed wireless node of the site.

If the user has credentials for only one of the service providers, the choice of credentials is straightforward. However, if the user has more than one set of credentials which may be used, the database service application 16 will use preference data associated with each of the sets of credentials to determine which one to use in preference to the other. This preference data will typically be related to the cost of access, and the database service application 16 will select a set of credentials use according to which provides the lowest cost of access available.

The user credentials are typically of limited validity and have one or more predetermined usage limits associated therewith in the communications system. The database service application 16 and/or the database administration node 26 are capable of monitoring usage of the limited validity user credentials, and in response to an event may conduct a transfer of limited validity user credentials between the user terminal and the database administration node 26. New credentials can be sent from the database administration node 26, either for immediate placing in the unencrypted user credentials list or for storage as encrypted user credentials which may be later activated. Partly used credentials can also be transmitted back to the database administration node 26 for re-use by another user.

The fixed wireless nodes of the communications system are geographically dispersed and, as stated earlier, each fixed wireless node broadcasts a signal containing at least first identification data, including a MAC address with or without a SSID.

In a preferred embodiment, the master database 34 of fixed wireless nodes which is accessed via a database administration node 26 in a communications system may be subdivided in several database subsets corresponding to different geographic areas such as regions of a country or to metropolitan areas. The master database 34 of fixed wireless nodes identifies fixed wireless nodes, each fixed wireless node being identified in the database by corresponding first identification data and also preferably by some associated second identification data such as geographic location data. Note that the master database 34 of fixed wireless nodes may contain thousands of fixed wireless nodes, and that there may be several fixed wireless nodes in the proximity of a particular location of a given geographic area.

Whilst the method of updating the master database 34 of fixed wireless nodes will now be described in relation to only one user terminal 10, it should be understood that preferably all user terminals in the system, or at least a large majority, are capable of performing such updates.

The present invention provides a method of operating a mobile user terminal in a communications system which comprises several steps. The mobile user terminal 10 has a sniffer application 15 and a radio transceiver (not shown) which are used to keep track not only of newly deployed fixed wireless nodes, herein referred to as new fixed wireless nodes, but also of existing fixed wireless nodes which have been moved to a new location or which have been removed entirely, herein referred to as missing fixed wireless nodes. The user terminal may include a positioning device, preferably a satellite positioning device, such as a global positioning system (GPS) receiver (not shown).

As mentioned previously, a replica database 18 is preferably stored in the user terminal. The replica database 18 includes a sites database, or fixed wireless nodes database, which contains information including site names, address, type of site, connection type, geographic location (including latitude and longitude coordinates), SSID and MAC address for the site.

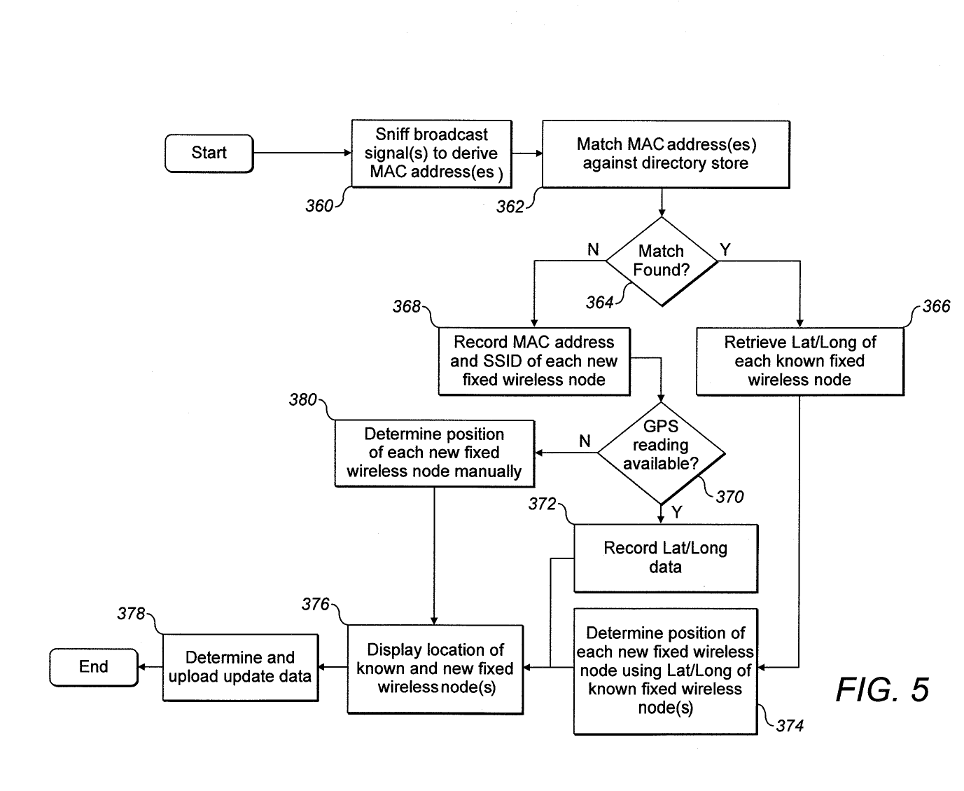

In the system of the present invention, in relation to the flow chart shown in FIG. 5, the sniffer application 15 of the user terminal 10 constantly makes a sweep of the area in the vicinity of the user terminal and monitors the reception of any broadcast signal being broadcast by fixed wireless nodes in the vicinity of the user terminal, in step 360, so as to derive the MAC addresses included in each received broadcast signal. The sniffer application 15 captures received signals from the receiver (not shown) of the user terminal and derives first identification data from these received signals. The sniffer application 15 then writes the first identification data into one or more log files which are stored in the data storage device 12 of the user terminal 10.

Thus, using the sniffer application 15, the database service application 16 may find all fixed wireless nodes for which a broadcast signal is currently available in its vicinity and derive first identification data, preferably a MAC address, of one or more fixed wireless nodes which the user terminal 10 currently is receiving a signal for.

In the first embodiment of the present invention, the database service application 16 reports update data to the database administration node on a regular basis, or alternatively on an irregular basis, in order to update the master database 34 of fixed wireless nodes.

The sniffer application may operate off-line, i.e. without the need for the user terminal to login to a fixed wireless node, and the database service application 16 to report to the database administration node when the user terminal is logged to a fixed wireless node.

Using its one or more log files, the database service application 16 derives update data from the first identification data, which is preferably the received broadcast MAC address, by comparing and matching, in step 364, the received broadcast MAC address of the one or more fixed wireless nodes with those in the replica database 18 of the user terminal, step 362. If a match is not found, i.e. a fixed wireless node is not referenced in the replica database 18, the MAC address, and SSID if any, of such a new fixed wireless node is recorded by the database service application 16, step 368. If at least one match is found, i.e. at least one fixed wireless node is referenced in the replica database 18, the latitude and longitude of each matching, or known, fixed wireless node may be retrieved by the database service application 16, step 366, for determining at a later stage the approximate position of a new fixed wireless node, in step 374, when a GPS reading is not available on the user terminal for instance.

In FIG. 5, following the detection of a new fixed wireless node in step 364, the database service application 16 determines in step 370 whether a GPS reading is available on the user terminal. If not, the approximate position of the new fixed wireless node is determined by the database service application 16, in step 374, by overlapping/cross referencing the latitude and longitude coordinates, as determined in step 366, of one or more fixed wireless nodes which are stored in the replica database 18 and whose broadcast signal is received by the user terminal. This occurs in environments where a GPS reading is not available, or when the user terminal does not include a satellite positioning system. However, as stated earlier, a user terminal may include a satellite positioning device, for example a global positioning system (GPS) receiver, which may provide a position of a new fixed wireless node to the database service application 16, step 372, if a GPS reading is available.

The precision by which the approximate position of a new fixed wireless node can be determined by the database service application 16 varies according to the number of broadcast signals from known fixed wireless nodes available to the user terminal, but the determination of this approximate position does not require the user terminal to be logged on to any fixed wireless node. The received signal of one known fixed wireless node would provide an approximate position in a circular area or annular area around the known location of the known fixed wireless node. In that case, the precision of location determination depends on a number of factors: whether the known fixed wireless node is indoors or outdoors; the transmission quality of the environment which varies as it depends on the presence of high rise buildings or trees for instance; the transmit power of the known fixed wireless node's signal; the known fixed wireless node's aerial orientation; the user terminal's receiver orientation; the accuracy in the fixed wireless nodes database of the geographic location of the venue in which the known fixed wireless node is located, and the accuracy of the location of this fixed wireless node within the venue. The received signal of two known fixed wireless nodes would provide a radial intersect based on signal overlap. The received signal of three or more known fixed wireless nodes provides a relative position corresponding to an intersection point by the well-known concept of triangulation which is based on the signal strength received from the three or more broadcast signals.

If there is no received signal of at least one known fixed wireless node available, a GPS reading may be available on the user terminal or, alternatively, if a GPS reading is not available, the user may manually add geographic information, step 380, by using the database service application 16 to search the replica database 18 for instance. The user may also be provided with directions by the database service application 16 to the nearest known fixed wireless node by referring to a map displayed on the user terminal's screen which may indicate the location of one or more known fixed wireless nodes. An indication of the distance to these one or more known fixed wireless nodes may also be provided based preferably on a round trip time (RTT) calculation. As the user moves, based on the order in which known fixed wireless nodes appear in the log file and their corresponding received signal strength, the database service application 16 may also provide the user with an indication of the direction in which he/she is heading. Again, these navigation capabilities provided by the database service application 16 do not require the user terminal to be logged on to any fixed wireless node.

Reverting to FIG. 5, in step 376, the database service application 16 may show on a screen of the user terminal the approximate location of any new fixed wireless node as well as the location of nearby known sites may be shown.

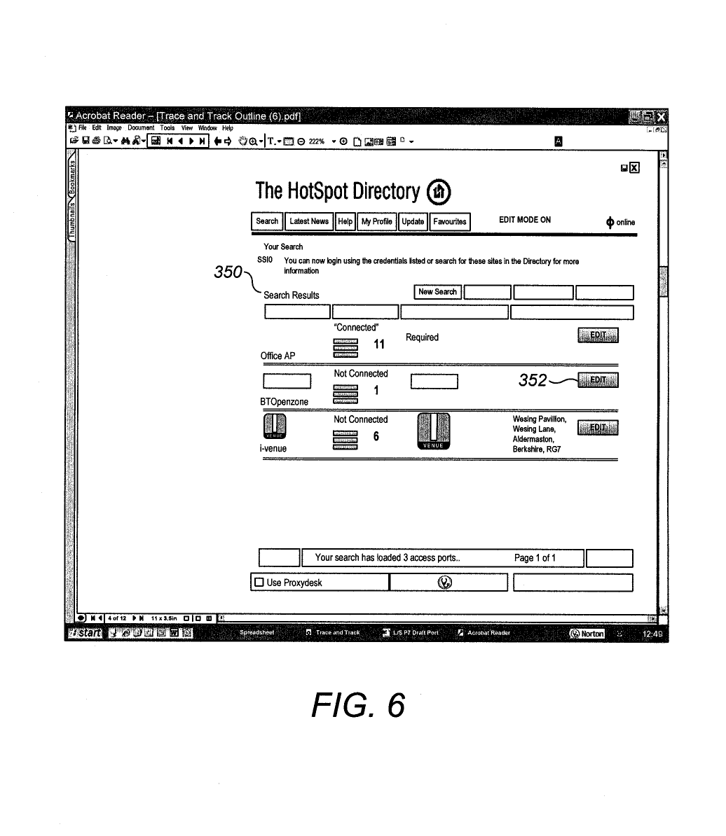

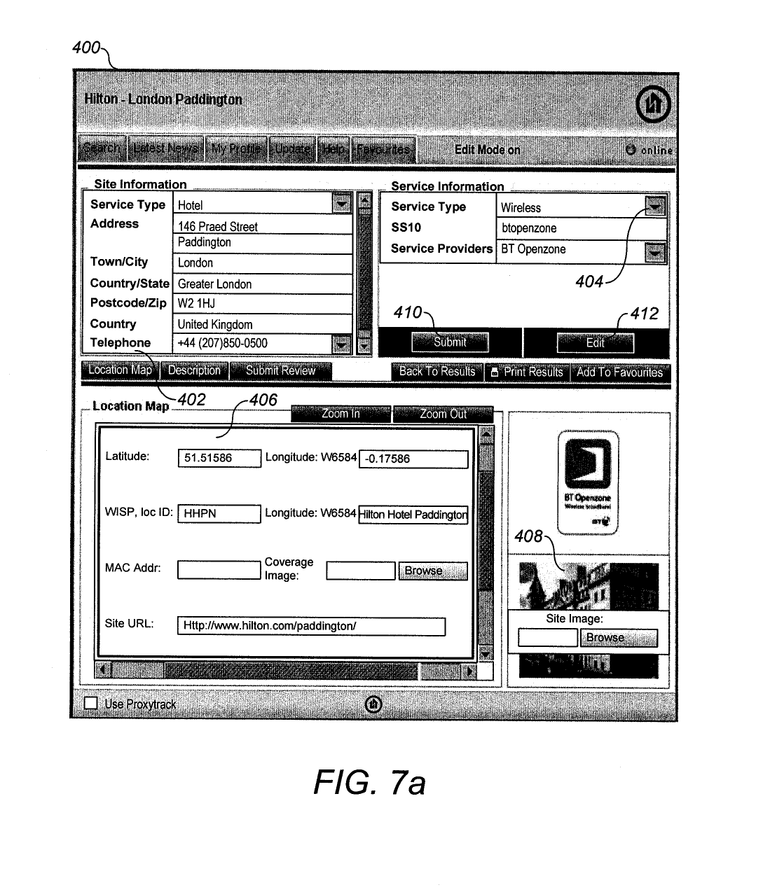

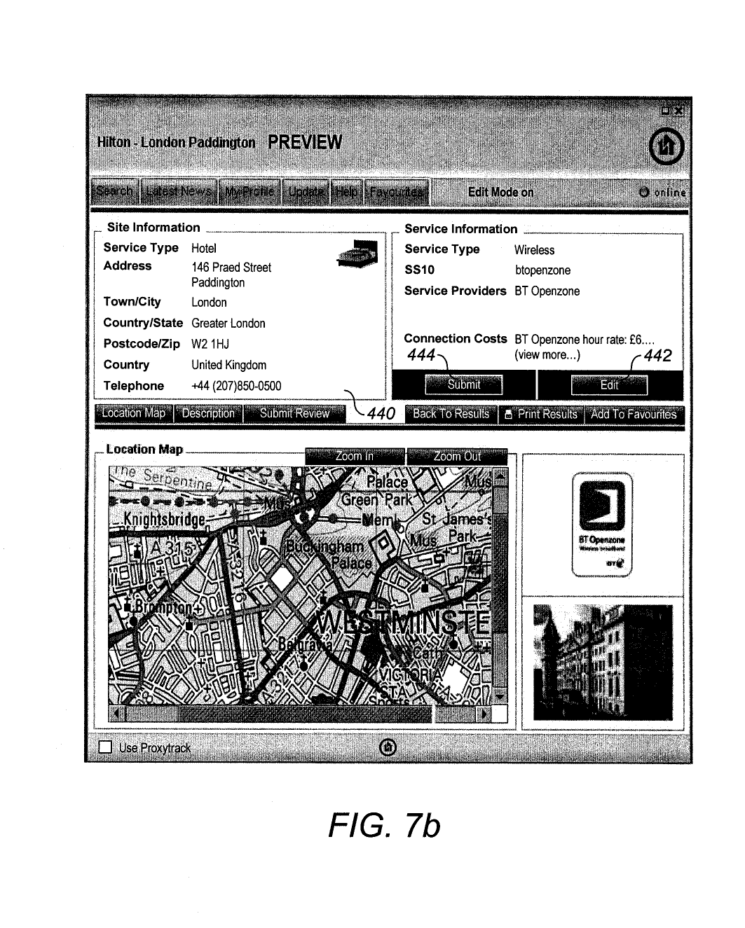

As shown in FIG. 6, based on received broadcast signals from different fixed wireless nodes located in the vicinity of a user terminal, the database service application 16 displays on a screen 350 of the user terminal a set of fixed wireless nodes or site details. Such a set of search results may be displayed without the need for the user terminal to be logged to a fixed wireless node. Details of fixed wireless nodes referenced in the replica database 18, i.e. known fixed wireless nodes, are displayed alongside details of fixed wireless nodes which are not referenced in the replica database 18 but whose broadcast signal is nevertheless detected by the user terminal, i.e. new fixed wireless nodes. For those new fixed wireless nodes, the SSID, when available, may be derived by the database service application 16 from the first identification data of their corresponding broadcast signal and displayed on the screen of the user terminal. An indication as to whether the user has credentials allowing access to the detected fixed wireless nodes, and site information details when available, is also provided on the screen by the database service application 16. By clicking on the edit button 352, the user is given the option to edit a site's details such as the SSID information or the site address for instance of any detected site. This information may be later uploaded by the database service application 16 or, alternatively, remains on the data storage device 12 of the user terminal 10. The editing option accessed via the edit button 352 will be explained in further detail in relation to FIGS. 7a and 7b.

Reverting to FIG. 5, in step 378, when the user is logged into a fixed wireless node, the database service application 16 of the user terminal may transmit/upload update data to the database administration node 26 in order to allow the master database 34 of fixed wireless nodes to be updated. The database service application 16 of the user terminal may, in association with the update data, also upload other data, such as a log file, to the database administration node 26 when online.

In the first embodiment, the update data is processed by the database service application 16 on the user terminal and indicates the presence of any new fixed wireless node not found in the replica database 18, and the absence of a known fixed wireless node whose broadcast signal has not been received by the receiver of the user terminal but whose details are nevertheless stored in the replica database 18. Such a missing fixed wireless node may have been moved to a new location outside the given geographic area or removed entirely. As mentioned previously, the update data may include geographic location data for any new fixed wireless node, the geographic location data being derived from an output signal of a geographic positioning system included on the user terminal or from the geographic location data of at least one known fixed wireless node.

In the first embodiment, when the user terminal is online or offline, the database service application 16 may use the data derived from the master database 34, such as the data stored in the replica database 18, in combination with the derived first identification data in order to provide a service to the user of the user terminal. The service is for instance based on a current location of the user terminal, the current location being determined based on the derived first identification data. As shown in FIG. 4, a user terminal based directory service may provide a user with a list of fixed wireless nodes located in the vicinity of the user terminal via which the user may access the communications network 2.

In a second embodiment of the invention, the description of the invention above in relation to the first embodiment also applies except that, in the second embodiment, the database service application 16 of the user terminal uploads one or more log files, or other data derived from the received broadcast signals, to the database administration node 26 when online. The log file preferably provides readings of received broadcast signals, each signal including a MAC address, and may also include signal strength data corresponding to the received broadcast signals. Update data is derived from the uploaded log file and may include one or more new fixed wireless node not found in the stored database 34 of fixed wireless nodes and/or one or more moved or missing fixed wireless nodes which are incorrectly identified in the stored database 34 of fixed wireless nodes. As in the first embodiment of the present invention, the approximate position of a fixed wireless node may be determined by the database administration node 26 from the position of at least one known fixed wireless node or from the received signal strength data included in the log file.

Having received the uploaded log files of one or more user terminals as described in the second embodiment, the database administration node then updates the stored database 34 of fixed wireless nodes by respectively adding any new fixed wireless node to the database and by removing any missing fixed wireless node from the database. A fixed wireless node may be added or removed from stored database 34 of fixed wireless nodes immediately when a single user terminal detects and reports an update or when the number of user terminals having detected and reported this update exceeds a pre-set threshold.

The database service application 16 of the user terminal may also use the log file data to provide real-time, or alternatively delayed, tracking information on the movement of a terminal user. One possible way of retrieving this tracking information would consist in correlating the timestamp associated with each received broadcast signal stored in the log file with the fixed wireless nodes identification data stored in the log file and the location data of these fixed wireless nodes stored in the stored database 34 or in the replica database 18.

With respect to the first embodiment of the present invention, FIG. 7a shows the user interface of the database service application of the invention, whereby the details of a new fixed wireless node, referred to as a site on FIG. 7a, are edited by a user. FIG. 7a shows an edit screen 400 containing selectable items and links to further parts of the application. The edit screen may be displayed in response to the user clicking on the edit button 352 of FIG. 6. The edit screen allows the user to manually enter and edit details for a new fixed wireless node in a site information section 402, in this case a site type such as a hotel, the address of the site, and contact information for the site, such as the telephone number. Service information details in a service information section 404 such as the type of service, the name and SSID of the service provider, and the connection costs associated with the service provider are also shown. The screen contains location map details 406 including approximate latitude and longitude of a new fixed wireless node which may be automatically inserted if at least another fixed wireless node has been identified or if a GPS reading is available at the user terminal, MAC address for the site and site URL.

Alternatively, or in addition, a street map (not shown) may be displayed on the screen. The approximate position/location of the new fixed wireless node may be indicated by an icon or any other form of indicator. The known fixed wireless node(s) which are in the vicinity of the new fixed wireless node may also be shown on the screen, each preferably associated with a reference number, with the possibility for the user to zoom in and zoom out on the map.

Reverting to FIG. 7a, the database service application 16 may also display a site image 408 on the edit screen 400. The user can manually report details of the new fixed wireless node by clicking on a submit button 410. Following the activation of the submit button 410, the edit screen shown in FIG. 7a is replaced by the preview screen 440 shown in FIG. 7b which includes the data previously filled by the user. The preview screen 440 allows the user to review the details corresponding to a new fixed wireless node. Clicking on the edit button 442 at that stage would bring the user back to the edit screen 400. Submission of the details corresponding to a new fixed wireless node and shown in the preview screen 440, is triggered by clicking on a submit button 444. However, details corresponding to a new fixed wireless node are uploaded to the database administration node 26 when the user is online.

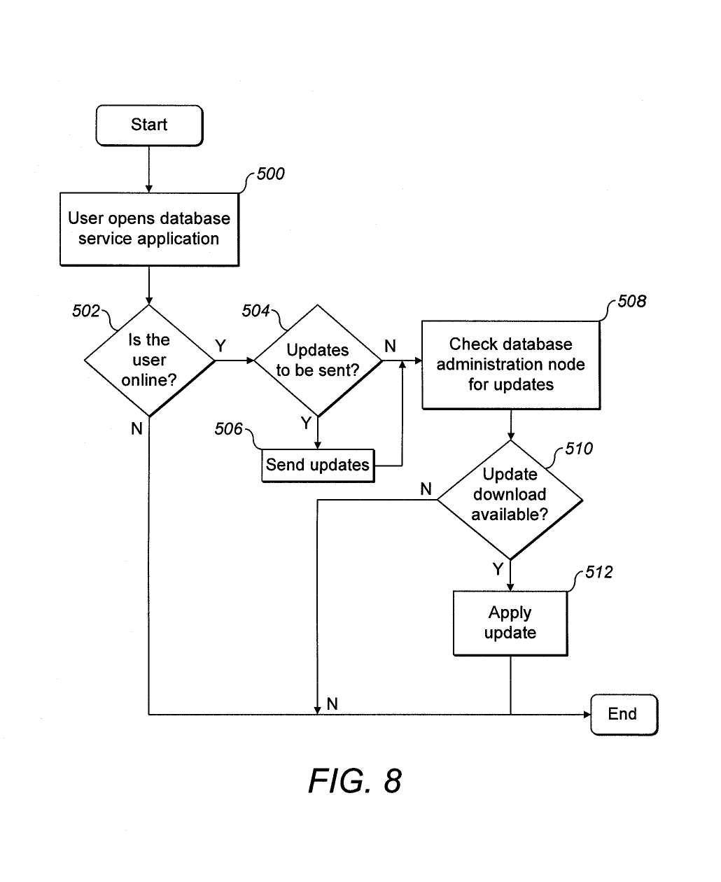

FIG. 8 illustrates a procedure carried out by the database service application 16 on a user terminal in order to transmit updates to the database administration node 26 and to receive updates from the database administration node 26. The procedure begins when the user opens the application 500 which then checks whether the user is on-line 502. If the user is not online, the updates are not sent and the procedure ends. If the user is currently online, the database service application 16 checks whether updates are to be sent 504, in which case it sends updates 506 to the database administration node 26. Updates are, for example, data updates as described in the first embodiment of the present invention or one or more log files as described in the second embodiment of the present invention which are transmitted to the database administration node in order to allow the stored database of fixed wireless nodes to be updated.

Next, the database service application 16 of the user terminal checks whether any updates are stored in the database administration node, in step 508. If available, step 510, the update is downloaded and applied, step 512. The update may include updates to the replica database 18, if any new site details are made available in the master database 34 of fixed wireless nodes as a result of updates having been uploaded to the master database. Other updates which may be applied may take the form of new user credentials which are to be stored directly in the user credentials wallet 20, and software updates.

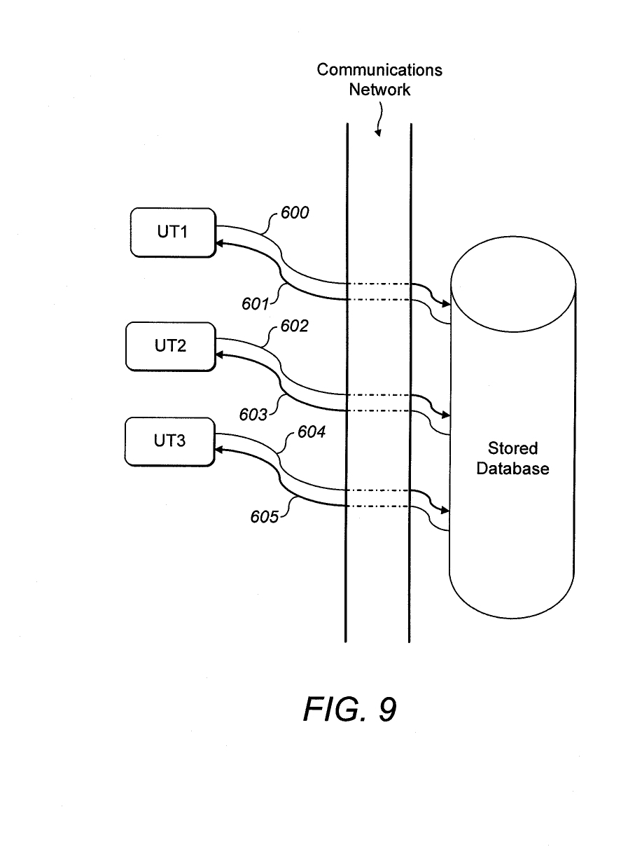

As mentioned earlier, in order to update the stored database 34 of fixed wireless nodes, the update data is uploaded from several user terminals. FIG. 9 shows schematically an example of an update procedure between three mobile user terminals UT1, UT2, UT3 and a stored database of fixed wireless nodes according to both embodiments of the present invention. When a user terminal is provided with network connectivity, a database service application 16 from each user terminal UT1, UT2, UT3 may upload update data 600, 602, 604 to the stored database of fixed wireless nodes. In response to update data from the user terminals UT1, UT2, UT3 having been received at the stored database of fixed wireless nodes, the stored database is updated using the received update data 600, 602, 604 and individual update data 601, 603, 605 may be transmitted/downloaded from the stored database of fixed wireless nodes to a service application of the respective user terminals UT1, UT2, UT3 via the communications network. The stored database may alternatively be updated using the received data of only one or two of the mobile user terminals UT1, UT2, UT3. Also the content of the respective downloaded update data 601, 603, 605 may be identical or different.

Embodiments of the present invention as described above thus enables a location database of fixed wireless nodes to be constantly updated, without making it necessary to physically scan on a regular basis every street in a given area, using for instance a fleet of scanning vehicles. Instead embodiments of the present invention use the data captured by user terminals, such data then being uploaded to a remote fixed wireless nodes database to enhance the database on an ongoing basis.

The above embodiments are to be understood as illustrative examples of the invention. Further embodiments of the invention are envisaged. For example, the fixed wireless nodes need not only be Wi-Fi or WiMax access points. They may implement other radio communications protocols. The replica database of each user terminal may also, for example, contain a part or all of the contents of the master database 34 of fixed wireless nodes.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

While various embodiments of the invention have been particularly shown and described, it will be understood by those skilled in the art that various changes in form and details may be made therein without departing from the spirit and scope of the invention as defined by the appended claims.

For example,

What is claimed is:

1. A method of operating a mobile user terminal in a communications system, the mobile user terminal having access to data derived from a stored database of fixed wireless nodes, said stored database identifying fixed wireless nodes which are geographically dispersed and which broadcast a signal containing at least first identification data, said fixed wireless nodes being identified in said stored database by said first identification data, said method comprising the steps of:
(a) monitoring received broadcast signals;
(b) deriving first identification data of fixed wireless nodes from said received broadcast signals;
(c) using data derived from said stored database in combination with said derived first identification data in order to provide a service to a user of said mobile user terminal;
(d) deriving update data from at least said derived first identification data; and
(e) transmitting said derived update data to a database administration node in order to allow said stored database of fixed wireless nodes to be updated.

2. A method according to claim 1, said mobile user terminal having a replica database derived from said stored database of fixed wireless nodes, wherein said update data is derived in step (d) by processing in relation to said replica database.

3. A method according to claim 2, wherein step (d) comprises the steps of:
comparing derived first identification data with first identification data of said replica database; and
determining from said comparison new fixed wireless nodes, if any, for which derived first identification data does not match an entry in said replica database.

4. A method according to claim 2, wherein step (d) comprises the steps of:
comparing derived first identification data with first identification data of said replica database; and
determining from said comparison missing fixed wireless nodes, if any, for which an entry in said replica database does not match derived first identification data.

5. A method according to claim 1, wherein said stored database includes, in addition to said first identification data, second data associated with said fixed wireless nodes.

6. A method according to claim 5, wherein said second data includes geographic location data.

7. A method according to claim 6, wherein said update data includes geographic location data.

8. A method according to claim 7, said mobile user terminal further having a satellite positioning system, said geographic location data in said update data being derived from an output signal of said geographic positioning system.

9. A method according to claim 7, said geographic location data in said update data being derived from said geographic location data of said second data associated with said fixed wireless nodes of said stored database.

10. A method according to claim 9, wherein said mobile user terminal does not include a satellite positioning system.

11. A method according to claim 1, said mobile user terminal having means to derive data representing signal strength of received broadcast signals.

12. A method according to claim 11, wherein said update data includes said signal strength data.

13. A method according to claim 1, said method comprising the further step of:
(f) receiving update data derived from said stored database of fixed wireless nodes in response to transmitting said derived update data.

14. A method according to claim 1, wherein said service provided in step (c) is a service based on a current location of said mobile user terminal, said current location being determined based on said derived first identification data.

15. A method of updating a stored database of fixed wireless nodes accessed via a database administration node in a communications system, said stored database identifying fixed wireless nodes which are geographically dispersed and which broadcast a signal containing at least first identification data, said fixed wireless node being identified in said database by first identification data, said method comprising the steps of:
receiving update data at said stored database from a service application of at least one mobile user terminal, said service application using data derived from said stored database in combination with first identification data which is derived from broadcast signals received at said at least one mobile user terminal in order to provide a service to a user of said mobile user terminal, said update data being derived from said derived first identification data; and
updating said fixed wireless nodes database with said received update data.

16. A method according to claim 15, said received update data comprising first identification data, said method comprising the further steps of:
comparing first identification data of said received update data with first identification data of said stored database; and
determining from said comparison new fixed wireless nodes, if any, for which first identification data of said received update data does not match an entry in said stored database.

17. A method according to claim 15, said received update data comprising first identification data, said method comprising the further steps of:
comparing first identification data of said received update data with first identification data of said stored database; and
determining from said comparison missing fixed wireless nodes, if any, for which an entry in said stored database does not match first identification data of said received update data.

18. A method according to claim 16, wherein said stored database includes, in addition to said first identification data, second data associated with said fixed wireless nodes.

19. A method according to claim 18, wherein said second data includes geographic location data.

20. A method according to claim 19, wherein said update data includes geographic location data.

21. A method according to claim 20, wherein said geographic location of said received update data is derived from said second data.

22. A method according to claim 20, wherein said received update data includes signal strength data derived from received broadcast signals at said user terminal, said geographic location of said received update data being derived from said signal strength data.

23. A method according to claim 15, wherein said at least one user terminal has a replica database derived from said stored database, said received update data being derived from said replica database.

24. A method according to claim 15, said method further comprising the step of transmitting update data from said stored database to a service application of at least one mobile user terminal in response to receiving update data from a service application of at least one mobile user terminal.

25. A computer-readable storage medium storing program code for causing a computer to perform a method of operating a mobile user terminal in a communications system, the mobile user terminal having access to data derived from a stored database of fixed wireless nodes, said stored database identifying fixed wireless nodes which are geographically dispersed and which broadcast a signal containing at least first identification data, said fixed wireless nodes being identified in said stored database by said first identification data, said program code providing a set of functions for performing the steps of:
(a) monitoring received broadcast signals;
(b) deriving first identification data of fixed wireless nodes from said received broadcast signals;
(c) using data derived from said stored database in combination with said derived first identification data in order to provide a service to a user of said mobile user terminal;
(d) deriving update data from at least said derived first identification data; and
(e) transmitting said derived update data to a database administration node in order to allow said stored database of fixed wireless nodes to be updated.

26. A computer-readable storage medium storing program code for causing a computer to perform a method of updating a stored database of fixed wireless nodes accessed via a database administration node in a communications system, said stored database identifying fixed wireless nodes which are geographically dispersed and which broadcast a signal containing at least first identification data, said fixed wireless node being identified in said database by first identification data, said program code providing a set of functions for performing the steps of:
receiving update data at said stored database from a service application of at least one mobile user terminal, said service application using data derived from said stored database in combination with first identification data which is derived from broadcast signals received at said at least one mobile user terminal in order to provide a service to a user of said mobile user terminal, said update data being derived from said derived first identification data; and
updating said fixed wireless nodes database with said received update data.

27. A system for updating a stored database of fixed wireless nodes in a communications system, said database identifying fixed wireless nodes which are geographically dispersed and which broadcast a signal containing first identification data, said fixed wireless node being identified in said database by said first identification data, said system including:
at least one mobile user terminal; and
communication means for allowing a service application of said at least one mobile user terminal to transmit update data to said stored database, said service application using data derived from said stored database in combination with first identification data derived from broadcast signals received at said at least one mobile user terminal in order to provide a service to a user of said mobile user terminal, said update data being derived from said derived first identification.

28. A system according to claim 27, said system further including:
a replica database stored on said at least one mobile user terminal, said replica database being derived from said stored database of fixed wireless nodes; and
communication means for allowing update data to be transmitted from said stored database to said service application of said at least one mobile user terminal in order to update said replica database.
